(19) United States
(12) Patent Application Publication
(10) Pub. No.: US 2017/0326460 A1
(43) Pub. Date: Nov. 16, 2017

(54) FANTASY SPORTS APPLICATION USING HISTORICAL PLAYERS AND METHOD OF USE

(71) Applicants: Jeremy Brooks, Salt Lake City, UT (US); Justin Brooks, Woods Cross, UT (US); Josh Adams, Stansbury Park, UT (US)

(72) Inventors: Jeremy Brooks, Salt Lake City, UT (US); Justin Brooks, Woods Cross, UT (US); Josh Adams, Stansbury Park, UT (US)

(21) Appl. No.: 15/154,898

(22) Filed: May 13, 2016

(51) Int. Cl. A63F 13/828; A63F 13/35

(52) U.S. Cl. CPC A63F 13/828; A63F 13/35

(57) ABSTRACT

A fantasy sports application or more specifically to a fantasy sports application that integrates the historically great “immortal” players onto a drafted team which includes players that are currently active in the sport. A user may challenge a second user to an online match via the application, instant message or through social media. The user who drafts the statistically better team wins the head-to-head competition.

### BACKGROUND

The fantasy sports industry is currently booming with the advent of inter-net and personal computers, and now even more so with the proliferation of personal hand held devices such as, tablet computers and smart phones.

There are myriad sports fantasy leagues that compete in office pools, on university campuses and leagues associated with sports broadcasting. However, the dominant platforms are presently the sports betting based programs run by the companies FanDuel® and DraftKings®. The gambling aspects of these fantasy sports leagues are currently being challenged under the gaming laws of the state of New York; this legal challenge and ruling may embolden other states to file similar lawsuits, or cause the federal government to legislate regulations, creating an environment where the sports betting fantasy programs can no longer operate.

Many fantasy sport applications are based around a current season with the player statistics accumulated during the course of the season. The statistics are applied to an algorithm to determine the overall impact the player will have on the fantasy team. This model requires that the fantasy league participant is active in the game or match for the entirety of the sports season in order to determine final results. The lengthy time commitment may not be realistic for many would be participants.

Additionally, there is an ongoing question regarding the impact many of the historical players would have in their respective sports during the modern era. This question is especially relevant for retired players that are considered an all-time great, all-star or a sports “immortal”.

What is needed is a fantasy sports application that does not include a gambling component, which can be played to conclusion in a reasonable duration and gives the user the opportunity to explore how the historically great players impact sport in competition with today's athletes.

### SUMMARY OF THE INVENTION

The disclosure of the present invention relates to a fantasy sports application or more specifically to a fantasy sports application that integrates the historically great “immortal” players onto a drafted team which includes players that are currently active in the sport. The challenge for the user is to learn about both the historical and current players, and draft them onto a team for head-to-head competition, against another user. The user who drafts the statistically better team wins the head-to-head competition.

A first embodiment of the present invention is a FANTASY SPORTS APPLICATION USING HISTORICAL PLAYERS AND METHOD OF USE wherein, an online user can challenge a second online user in a head-to-head team draft competition. The online challenge may be sent via the present fantasy sports application, text, instant message, or through social media, such as Facebook®, Instagram®, Twitter® or another existing or yet to be created program. The application including a database comprised of full season statistical information for both historical and active players, the statistical information is compressed through a standard algorithm to award each player a “fantasy points” score. A research area is available where a user can choose a sport and then look at the statistical information for each player within that sport by the field or roster position of that player. As the user reviews the players they are encouraged to remember the statistically better players for use during competition or they will have the ability to mark certain players as “favorites”. During an upcoming draft, players which are marked as favorites will be placed at the top of the available draft list, reminding the user of the better players and expediting the draft process. Other historical players will be marked as “immortals” and can be added to a user's favorites but may not be available for the user to draft unless the user has accumulated enough points or salary by participation, winning matches, through a direct points purchase or by winning points on a wheel of chance.

In one embodiment the users will be ranked on a series of tiers allowing novice users to compete against other users with a similar skill set and advanced users to challenge users which compete competently at their level. Users can only challenge other users on their tier but can directly challenge the top of the tier or challenge the most successful user within the tier or the player holding the title of “king of tier”. A king of tier will initially be determined by the user within the tier having the most points and the king of tier will maintain his title by successfully defending against challengers from within the tier. The king of tier will have a time period, such as 24 hours, to respond to a challenge in order to maintain the title. If the king loses a challenge, the challenger will become the new king of tier. If the king fails to respond to a challenge within the allotted time, the user having the next highest points total within the tier will automatically become the king of tier. If a king continues to win matches he will eventually garner enough points and will be moved onto the next tier and again the user with the next highest points total will be crowned as king of tier. The user profile for the user that is currently crowned as king of tier will have a distinguished crown placed on their profile.

In other embodiments, it is contemplated other distinguishing titles may be used to acknowledge successful users within a certain community, such as best of state, university supremacy, professional pubescence and world domination.

In one embodiment the user information will be stored online as a username, password, email address and phone number if the user desires to be contacted for matches via SMS or phone text message. In the event a user desires to challenge another user to a match, a list of users will be displayed showing first, users the challenger has marked as “friends”, then other users that are currently online and finally users that are currently offline. A notification will be sent to the challenged user and they will have a set time limit to respond to the challenge. If the challenge is accepted, the users will be moved to a draft page or “draft room” where a virtual coin toss will determine which user is entitled to draft the first player. In order to maintain fairness throughout the draft process, the draft will be conducted as a snake draft divided into rounds where one round is available for every field position or roster spot on the team. The user winning the coin toss will make their first round pick followed by a first round pick of the second user; the second user will now make the first pick in the second round followed by the second round pick of the coin toss winner. This methodology allows the first pick in each round to snake back and forth between the users and creates a fair and balanced draft process.

Once the draft process is complete the application will calculate results and declare a winner. Each participant in the draft will be award a point, or points for participating in a match. The winner will be award additional points. Points accumulated will allow a user to advance between tiers, use them to purchase spins on the wheel of chance or purchase a time speed up.

It is contemplated that in order to diversify competition and incentivize users to extend themselves out to other players, two distinct users may only compete against one another a certain number of times within a designated time period. In one embodiment players may only compete head-to-head three times within a 24 hour period. In another embodiment this may be any combination of player match occurrences versus any time period, for example, but not limited to, twice within a 24 hour period or 10 matches with in a one week time period.

In one embodiment a user may purchase, using points or as an in application payment, a “time speed up” which will allow a player to challenge a second player to additional matches within a restricted time period. A time speed up may also be won on the wheel of chance.

One embodiment of the present invention includes a “wheel of chance” having a plurality of awards available on the wheel. The awards may include additional points, to advance the user within the tier, or use toward other purchases within the application, the award may be a time speed up or access to an immortal player. It is contemplated that each spin will result in some type of an award which will be removed from the wheel once awarded, but the wheel of chance will be weighted not to immediately award the larger prizes such as immortal players.

In another embodiment of the present invention the users will have the option to draft within limited criteria, such as users will be limited to drafting only players that are residents of a certain state, attended a certain university or played on a certain professional team. This option will allow users to entertain questions like, which state produced the best basketball players, Indiana or California or which city has the better historical football program, the Pittsburgh or Miami.

In yet another embodiment of the present invention the users will have the ability to draft players from more than one sport onto an ultimate sports team having the respective positions from each sport. It is contemplated that the user will select three sports, challenge another user, and then complete a draft where both current and historical players from the respective sports are selected. This format will test user knowledge in more than one sport at a time.

### BRIEF DESCRIPTION OF DRAWINGS

The following description of the embodiments can be understood in light of the Figures which illustrate specific aspects of the embodiments and are part of the specification. Together with the following description, the Figures demonstrate and explain the principles of the embodiments. The same reference numerals or word descriptions in different drawings represent the same element, and thus their descriptions may be omitted.

FIG. 1 is a logic diagram of the present invention,

FIG. 2 is draft screen of the present invention, and,

FIG. 3 is a wheel of chance of the present invention.

It is to be understood that the above mentioned arrangements are only illustrative of the application of the principles of the present disclosure. Numerous modifications or alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations form, function and manner of operation, may be made without departing from the principles and concepts set forth herein.

### DETAILED DESCRIPTION OF THE DRAWINGS

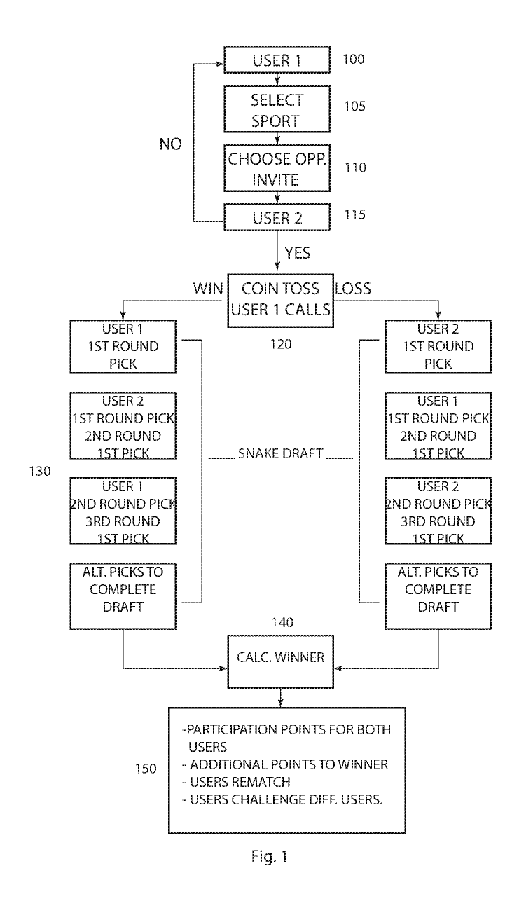

FIG. 1 is a logic diagram for one embodiment of the present invention or fantasy sports application, including a first user 100, who will first select a sport platform for a mock draft, the first user 100 chooses another user from a list of users 110 where the list will first list “friends” of the first user 100 followed by other users currently online and then all remaining users. Users will be listed in alphabetical orders within the primary sort criteria. Once the first user 100 has selected an opponent or second user 115, the second user 115 will have the opportunity to accept or reject the invitation to compete. If the invitation to compete is accepted a coin toss 120 will be used to decide which user will make the first fantasy player selection. The fantasy player selection is configured in a “snake draft” 130 where if the first user 100 wins the coin toss, they will make the first player selection in the first draft round. The second user 115 will then make their first round pick and immediately make their second round player selection. This process is repeated until each field or roster position is filed for the respective sport. With the draft complete the application will automatically calculate a winner 140. Each user will be awarded one or more points for participating in the match and the winner will be awarded additional points for their efforts 150. The users may choose to have a rematch or may initiate a challenge to a different user and restart the process.

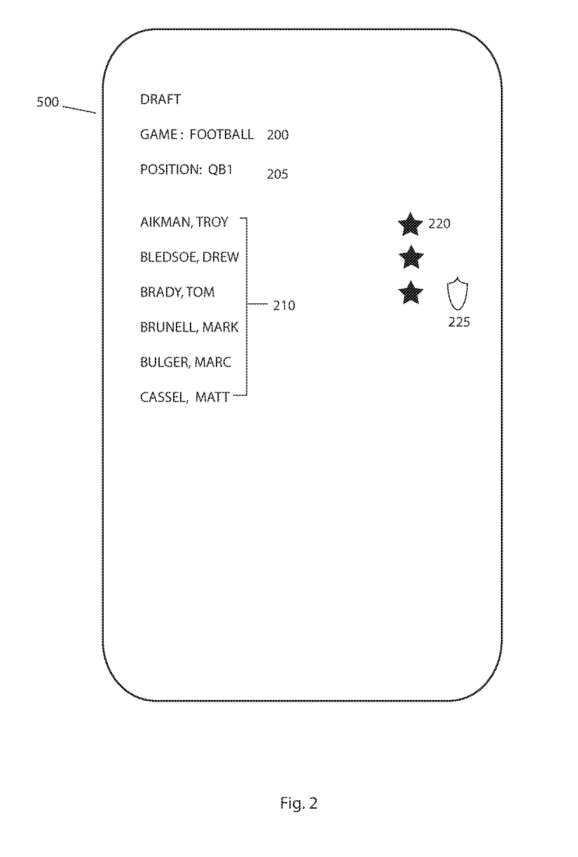

FIG. 2 is a representative embodiment of a player draft screen. The player 210 information will be available from the application on the screen 500 of a tablet or smart phone. Players which have been designated as “favorite” by the user, will be listed first, and include an indicator 220 such as a star. Retired players which can be considered “immortal” historical players will also include an indicator 225. The remaining players will be listed in alphabetical order. The application will also indicate the sport selected 200 and the player position currently being filled 205.

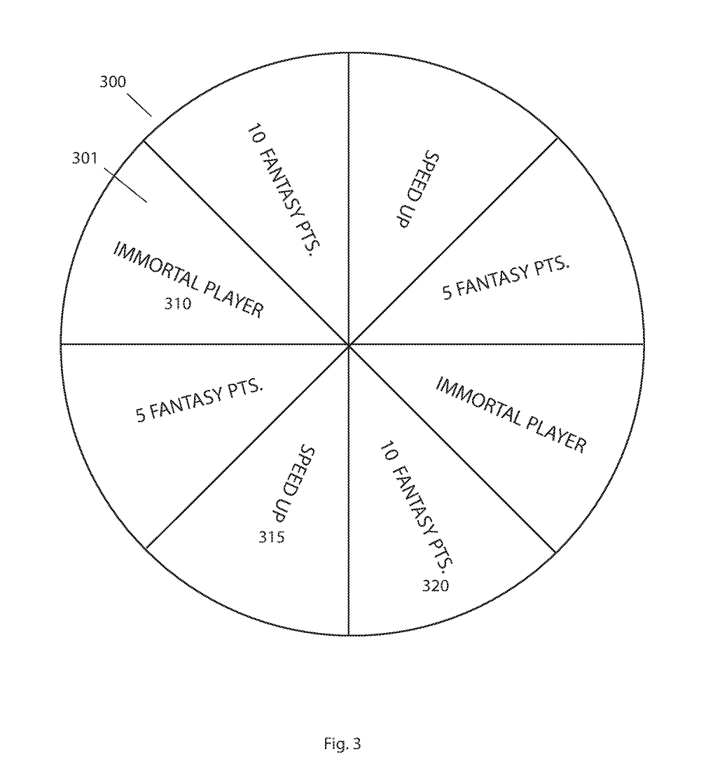

FIG. 3 in a representative view of the “wheel of chance” 300, the wheel 300 including a plurality of divisions 301 where the possible spin outcomes are indicated. A user will have the opportunity to earn immortal players 310, a play speed up 315 or additional awards such as fantasy points or salary points 320.

1. A fantasy sports application, comprising;
a server based database including,
a player list including,
active players and historical players,
each player identified by, name, sport and roster position,
a statistical complete season performance data from each player,
an algorithm to compress complete season data into a fantasy score for each player,
a list of program users allowing,
a first program user from the list of program users to challenge a second program user to a match via an online invitation,
a virtual coin toss application to determine a draft selection order,
a team roster for each user comprised of a sport position list,
a draft selection list of players,
the draft selection list limited by sport and position,
a draft wherein each user fills his roster with players from the draft selection list,
a calculation algorithm to determine the highest fantasy score from each team roster, and,
a points allocation to each participating user.

2. The fantasy sports application of claim 1 wherein the draft is conducted as a snake draft.

3. The fantasy sports application of claim 1 wherein the user can designate one or more favorites on the player list.

4. The fantasy sports application of claim 1 wherein the application can designate one or more immortal players from historical players on the player list.

5. The fantasy sports application of claim 4 wherein the immortal players may have a higher fantasy score.

6. The fantasy sports application of claim 4 wherein the immortal players may not be available for the draft unless the user drafting the immortal player has accumulated enough points, through one or more of, participation, winning matches and an in application purchase.

7. The fantasy sports application of claim 4 including a wheel of chance wherein a user may spin to gain one or more of, points or access to an immortal player.

8. A method competing in a fantasy sports application, comprising;
providing a server based database including,
a player list including,
active players and historical players,
each player identified by, name, sport and roster position,
statistical complete season performance data from each player,
an algorithm to compress complete season data into a fantasy score for each player,
a list of program users allowing participating users as,
a first program user from the list of program users to challenge a second program user to a match via an online invitation,
providing a virtual coin toss application to determine a draft selection order,
providing a team roster for each user comprised of a sport position list,
providing a draft selection list of players,
the draft selection list limited by sport and position,
providing a snake draft wherein each user fills his roster with players from the draft selection list wherein,
the coin toss winner makes a first choice of one player for the first sport position on the users team roster from the draft selection list,
the coin toss looser makes a second choice of one player for the first sport position on the users team roster from the draft selection list and the coin toss looser makes a first choice of one player for the second sport position on the users team roster from the draft selection list,
the coin toss winner makes a second choice of one player for the second sport position on the users team roster from the draft selection list and the coin toss winner makes a first choice of one player for the third sport position on the users team roster from the draft selection list,
the coin toss winner and coin looser, as users, continue making two alternating draft picks until each team roster position is full,
providing a calculation algorithm to determine the highest fantasy score from each team roster,
a point allocation to each user for participation, and,
an additional allocation of one or more points to the draft winner.
